(19) United States
(12) Patent Application Publication
(10) Pub. No.: US 2013/0325523 A1
(43) Pub. Date: Dec. 5, 2013

(54) AUTHENTICATION SYSTEM OF ELECTRONIC TICKETS AND THE AUTHENTICATION METHOD FOR THE SAME

(71) Applicants: Wei-Chun HUANG, Taipei City (TW); Tsung-Hsing HSIEH, Taipei City (TW)

(72) Inventors: Wei-Chun HUANG, Taipei City (TW); Tsung-Hsing HSIEH, Taipei City (TW)

(21) Appl. No.: 13/488,780

(22) Filed: Jun. 5, 2012

(51) Int. Cl. G06Q 10/02

(52) U.S. Cl. 705/5

(57) ABSTRACT

An authentication system of electronic tickets and the authentication method for the same is disclosed. The authentication system includes a system terminal server, an electronic device, an authentication device, and an authentication reader. The authentication device is electrically coupled to the electronic device via a wired transmission interface, and communicates with an authentication reader via a wireless transmission interface. The user purchases an electronic ticket via the electronic device from the system terminal server. The user receives the ticket data and loads the ticket data in to the authentication device. When the user wants to use the electronic ticket, the authentication reader wirelessly accesses to ticket data in the authentication device via the wireless transmission interfaces such as Near Field Communication (NFC) or Radio Frequency (RF) and user is allowed to use the electronic ticket after passing authentication.

### BACKGROUND OF THE INVENTION

1. Field of the Invention

The present invention relates to electronic tickets, in particular relates to an authentication system of one-time electronic tickets and authentication method.

2. Description of Prior Art

As the civilization advances, the living standards of people progress and people start to admire various kinds of cultural events.

FIG. 1 is a schematic diagram of ticket authentication according to the prior art. Generally, users go to different cultural events such as concerts, exhibitions, films or games, and ticket agents check on the tickets at the entrance. As shown in FIG. 1, user 11 generally purchases a paper ticket 2 in advance. The ticket is checked by the ticket agent 12 at the entrance. The ticket agent 12 verifies the ticket details (date, time, place, play), and the user is allowed to enter. Further, the ticket agent 12 controls the checking equipment, for example a gate 3, via a computer or other devices. Thus, the paper ticket 2 is verified to be correct, the gate 3 is then open for the user 11 to enter.

However, a main disadvantage of the above checking method with a paper ticket 2 is that the checking speed is too slow. The event organizer has to hire many ticket agents 12 at the event venue which is cost consuming as a result of high labor costs. Thus, a new ticket checking method, electronic ticket is introduced in the market, which does not require a ticket agent 12.

FIG. 2 is a schematic diagram of electronic ticket authentication according to the prior art. As shown in the diagram, the user 11 uses a smart electronic device 4 connecting to the internet and purchasing an electronic ticket on the network. Upon the purchase is completed, the electronic device 4 receives the ticket data of the electronic ticket. At the entrance, the user uses the electronic device 4 as a physical ticket, and the ticket checking is performed by an authentication reader 5.

For example, the ticket data can be a two dimensional bar code. At the entrance, the user displays the two dimensional bar code in the electronic device 4. The two dimensional bar code is scanned by the authentication reader 5. Further, the electronic device 4 is an electronic device having a Near Field Communication (NFC) interface or a Radio Frequency (RF) interface. When the user is at the entrance, the authentication reader 5 receives the ticket data via a wireless transmission interface such as a NFC or a RF interface etc. for performing authentication.

However, in the above mentioned method, the ticket data is downloaded to the electronic device 4 and bundled to the electronic device 4 when the user 11 uses the electronic device 4 for purchasing the electronic ticket. That means, when the user 11 uses an electronic ticket at the entrance, it is required to carry the electronic device 4, the user 11 is not allowed to move the electronic ticket from the electronic device 4. Accordingly, the user 11 cannot resale the electronic ticket. The method is not convenient to part of the users.

### SUMMARY OF THE INVENTION

The objective of the present invention is providing an authentication system of electronic tickets and the authentication method. A user is allowed to load the purchased electronic ticket into an authentication device having wireless transmission interfaces such as NFC or RF interfaces, which is convenient to user to carry. In addition, the authentication device is used for performing authentication on the electronic ticket.

In order to achieve the above goal, the authentication system of the present invention includes a system terminal server, an electronic device, an authentication device, and an authentication reader. The authentication device connects with the electronic device via a wired transmission interface, and communicates with the authentication reader via the wireless transmission interface. The user purchases an electronic ticket and receives the ticket data from system terminal server via electronic device. The ticket data is loaded to the authentication device and the authentication reader wirelessly accesses the ticket data in the authentication device via wireless transmission interfaces such as a NFC or a RF interface when the user desires to use the electronic ticket. Upon the authentication is completed, the user is allowed to use the electronic ticket.

The advantage of the present invention is that a user connects to a system terminal server via a smart electronic device for purchasing an electronic ticket on a network. When using the electronic ticket, the ticket data of an electronic ticket is loaded from the electronic device to an authentication device having a wireless transmission interface. The authentication device receives the authentication on the electronic ticket by the authentication reader. The advantage is that the electronic device used by the user for purchasing the electronic ticket is not required to have a RF or a NFC wireless transmission interface, and the user still is allowed to use the electronic ticket with the authentication device of the authentication system according to the present invention.

Further, the main bottleneck of the current online tickets purchase system is that, the electronic ticket is bundled to one smart mobile device which the user used for purchasing the electronic ticket on the network. In addition to that the electronic ticket is bundled to the smart mobile device, the user is not allowed to resale the electronic ticket, which is inconvenient to the user. As mentioned above, the authentication system and the authentication method of the present invention effectively increases the flexibility of using an electronic ticket.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 is a schematic diagram of ticket authentication according to the prior art;

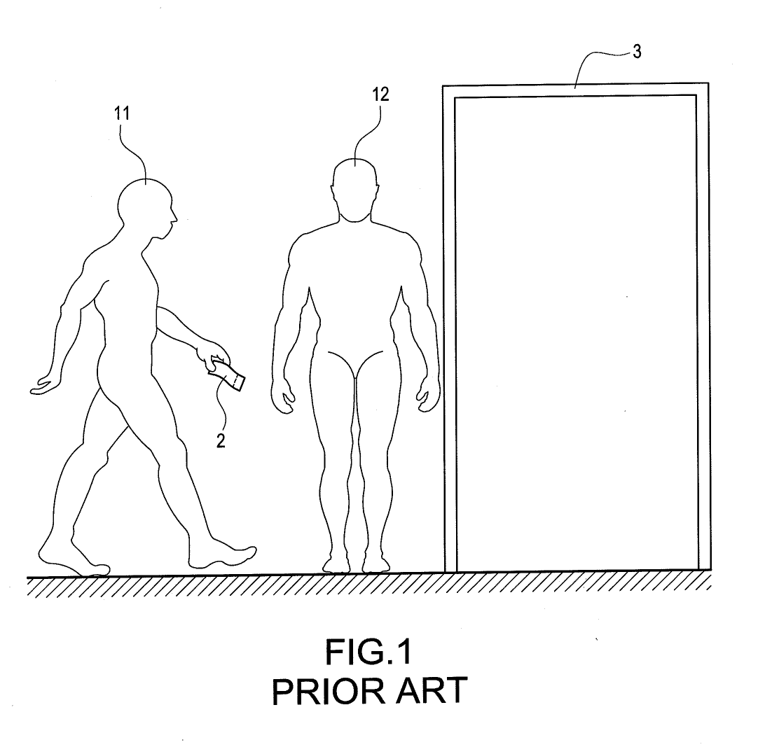

FIG. 2 is a schematic diagram of electronic ticket authentication according to the prior art;

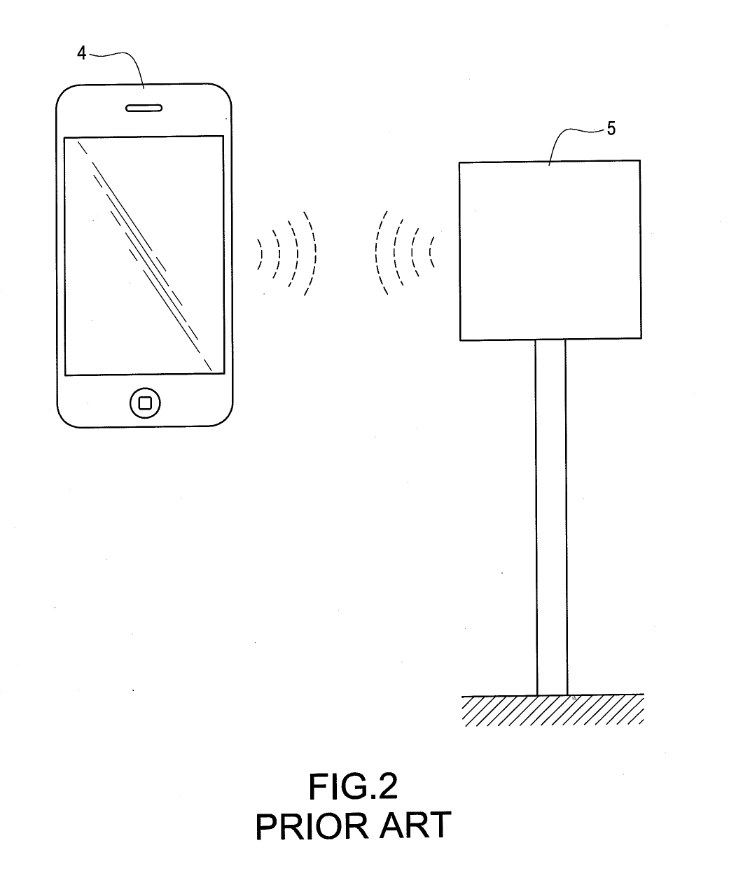

FIG. 3 is a system architecture diagram of a preferred embodiment according to the present invention;

FIG. 4 is a flow chart of electronic ticket authentication of a preferred embodiment according to the present invention;

FIG. 5 is a block diagram of the authentication device of a preferred embodiment according to the present invention;

FIG. 6 is a flow chart of electronic ticket authentication of another preferred embodiment according to the present invention;

FIG. 7A is a connection schematic diagram of the authentication device of the first preferred embodiment according to the present invention;

FIG. 7B is a connection schematic diagram of the authentication device of the second preferred embodiment according to the present invention;

FIG. 8 is a connection schematic diagram of the authentication device of the third preferred embodiment according to the present invention.

### DETAILED DESCRIPTION OF THE INVENTION

Embodiments are provided in the following in order to further detail the implementations of the present invention in the summary. It should be noted that objects used in the diagrams of the embodiments are provided with proportions, dimensions, deformations, displacements and details are examples and the present invention is not limited thereto and identical components in the embodiments are the given same component numbers.

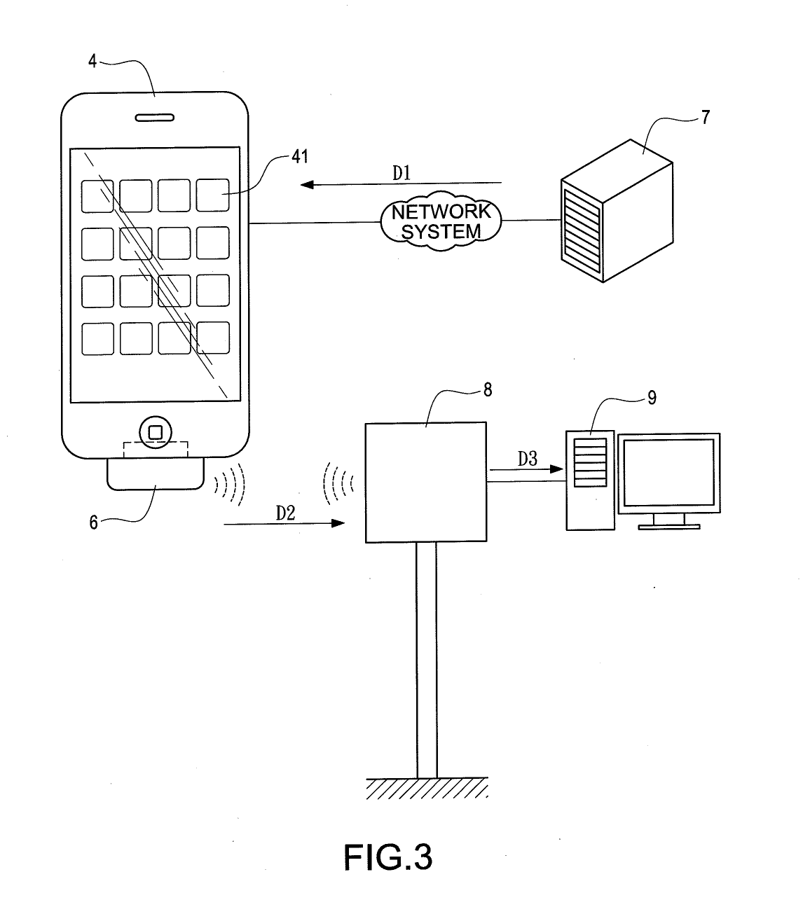

FIG. 3 is a system architecture diagram of a preferred embodiment according to the present invention. As shown in the diagram, the authentication system of electronic tickets according to the present invention includes an electronic device 4, an authentication device 6, a system terminal server 7, and an authentication reader 8. The system terminal server 7 is allocated in a cloud network belong to the issuing party of electronic tickets. The electronic device 4 and the authentication device 6 belong to purchaser/user of the electronic tickets. The authentication reader 8 is disposed at the place checking the electronic ticket and belongs to the ticket agent.

The authentication system of the present invention is applicable to using and authenticating of various one-time electronic tickets, such as concerts, exhibitions, movies, or games. The system terminal server 7 is used for issuing the electronic ticket provided for user purchase and for recording the ticket data (such as date, place, seats and price etc.) of each electronic ticket. Substantially, the ticket data is encrypted by a password of the system terminal server 7, only the device which is informed of the password of the system terminal server 7 (for example the authentication reader 8) is able to decrypt the ticket data.

The electronic device 4 can be a smart electronic device of different kind, such as smart phone, tablet PC and network television, and is not limited thereto. The electronic device 4 connects to the system terminal server 7 via the network system. Further, the user uses the electronic device 4 for purchasing the electronic tickets from the system terminal server 7 on the network. Upon the purchase is completed, the ticket data of the electronic tickets is downloaded and saved in the electronic device 4.

In details, the electronic device 4 is installed with an application program 41 provided by the issuing party of the electronic ticket, the user connects to ticket purchase webpage provided by the system terminal server 7 via the application program 41 for purchasing the electronic tickets. In addition, the electronic device 4 downloads the ticket data of the purchased electronic tickets via the application program 41.

According to the present invention, the authentication device 6 is a device having dual transmission interfaces. The authentication device 6 physically connects with the electronic device 4 via a wired transmission interface, and wirelessly transmits data with the authentication reader 8 via a wireless transmission interface. Thus, the user is allowed to purchase an electronic ticket with the electronic device 4 without a wireless transmission interface, and loads the ticket data of the electronic tickets into the authentication device 6 when the user desires to use the electronic ticket. The wireless transmission interface of the authentication device 6 communicates with the authentication reader 8 to enable the authentication reader 8 to wirelessly authenticate the electronic ticket.

The authentication device 6 is electrically coupled with the electronic device 4 via the wired transmission interface. The user loads the ticket data saved in the electronic device 4 to the authentication device 6 when the user desires to use the electronic ticket. When the authentication device 6 loads the ticket data, the connection with the electronic device 4 is disconnected. The user directly uses the authentication device 6 as a physical ticket. In short, the user is not required to carry the electronic device 4 during the ticket authentication at the entrance.

In details, the ticket data downloaded from the system terminal server 7 at the electronic device 4 is the first ticket information D1. The first ticket information D1 is encrypted by the password of the system terminal server 7. When the first ticket information D1 is loaded to the authentication device 6, the authentication device 6 encrypted the first ticket information D1 and generates the second ticket information D2. The authentication device 6 performs encryption with the default device identification code, but is not limited thereto.

The authentication reader 8 is disposed at the entrance of a venue using the electronic tickets, such as concerts, exhibition, movies, or games. Or, the authentication reader 8 can be a Personal Digital Assistant (PDA) having a wireless transmission interface carried by a ticket agent for perform authentication on the second ticket information D2 of the authentication device 6 carried by the user. The authentication reader 8 wirelessly receives the second ticket information D2, and decrypts the second ticket information D2 to generate the third ticket information D3. Further, the third ticket information D3 is used for confirming the information such as the using date, time, place, seats and price is in line with using requirements.

In further details, the authentication reader 8 is provided by the issuing party of the electronic ticket, or a contract is signed with the issuing party in order to receive the password of the system terminal server 7 and the using requirements of the electronic ticket. Also, the authentication reader 8 receives the second ticket information D2 from the authentication device 6 and at the same time requests the device identification code of the authentication device 6 from the authentication device 6. Thus, the authentication reader 8 decrypts the second ticket information D2 via the device identification code and the password of the system terminal server 7 and generates the third ticket information D3. Also, the password is used for confirming if the second ticket information D2 is legitimately purchased from the system terminal server 7. The device identification code is used for confirming if the second ticket information D2 is correctly processed to load into the authentication device 6.

At the venue using the electronic tickets, the authentication reader 8 connects with a front desk terminal 9, and transmits the third ticket information D3 to the front desk terminal 9 after the decryption. The front desk terminal 9 records information of the concerts, exhibitions, movies or competitions, the issuing party of the electronic ticket records the using status of the electronic ticket via the front desk terminal 9 and determines if the electronic ticket is in line with the using requirements (i.e. confirming if the data, time, play, and place is correct).

Further, the authentication reader 8 may connect to the checking equipments at the entrance, such as gate switch (not shown in the diagram). After the electronic ticket authentication is completed, the gate is then open for the user to enter. Nonetheless, the above is one of the preferred embodiments of the present invention, and is not limited thereto.

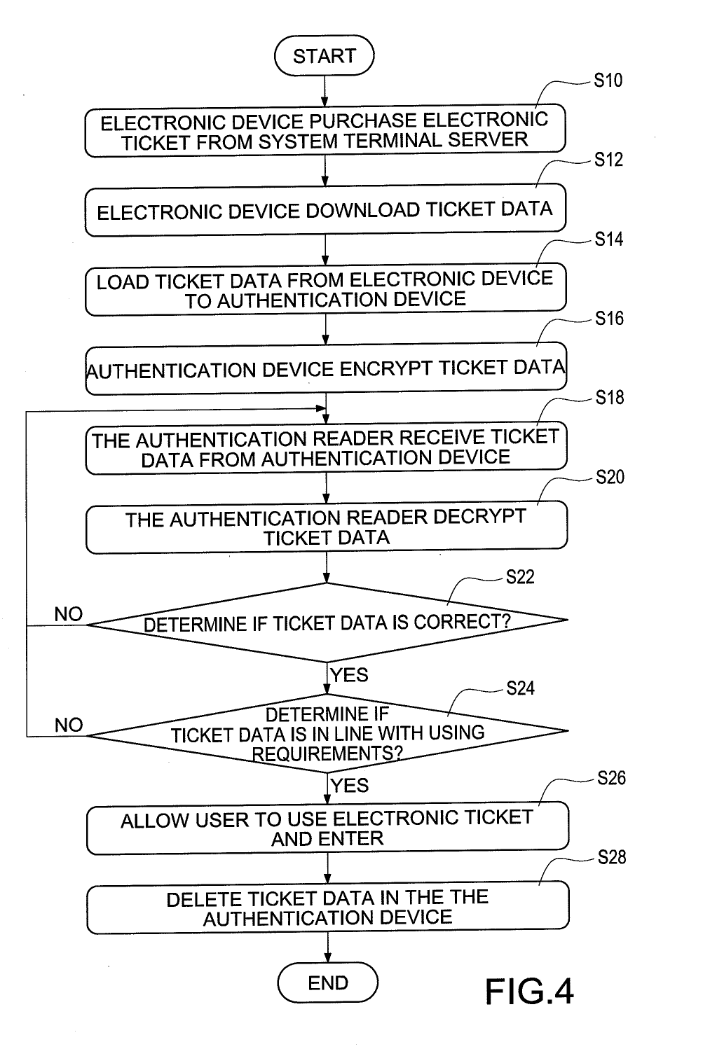

FIG. 4 is a flow chart of electronic ticket authentication of a preferred embodiment according to the present invention. According to the authentication method of the above authentication system, firstly, an user operates the electronic device 4 to connect to the system terminal server 7 for purchasing the electronic ticket by the application program 41 in the electronic device 4 (step S10). After the purchase is completed, the electronic device 4 downloads the first ticket information D1 of the electronic ticket via the network interface (step S12).

When the user desires to use the electronic ticket, the user operates the electronic device 4 to load the first ticket information D1 from the electronic device 4 to the authentication device 6 electrically coupled to the electronic device 4 (step S 14). In further details, the user may directly load the first ticket information D1 into the authentication device 6 via the application program 41 in the electronic device 4, but is not limited there t.

The authentication device 6 receives the first ticket information D1 and encrypts the first ticket information D1 (step S 16), and generates the second ticket information D2. Lastly, the authentication reader 8 is allowed to wirelessly access the second ticket information D2 recorded in the authentication device 6 (step S 18). The authentication reader 8 receives the second ticket information D2, and decrypts the second ticket information D2(step S20) and generates the third ticket information D3. In addition, the authentication reader 8 (or the front desk terminal 9) determines if the second ticket information D2 is correct by the decryption process (step S22).

As mentioned above, if the second ticket information D2 is incorrect, the method moves to the step S18, the authentication reader 8 communicates with the authentication device 6 again, and re-accesses the second ticket information D2. On the other hand, if the second ticket information D2 is correct, the ticket agent or the front desk terminal 9 further determines if the electronic ticket of the user is in line with using requirements based on the content of the third ticket information D3 (step S24).

As mentioned above, if the electronic ticket is not in line with the using requirements, the user is rejected to enter by the ticket agent. The method moves back to the step S18, the authentication reader 8 re-accesses the second ticket information D2. On the other hand, if the electronic ticket is in line with the using requirements, the user is allowed to enter by the ticket agent (step S26). Or, the checking equipments are controlled by the authentication reader 8 or the front desk terminal 9 at the entrance to allow the user to enter at the entrance. Thus, labor cost is lowered because it is not required to hire onsite ticket agents.

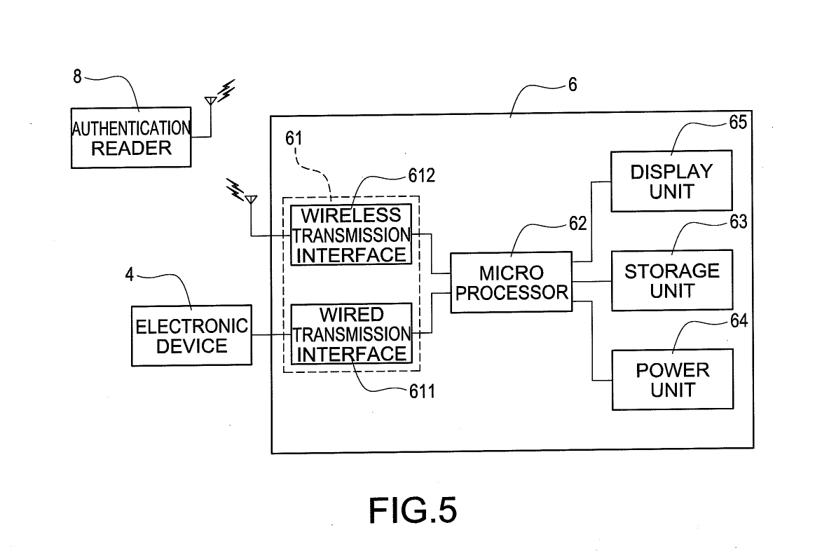

It should be noted that, the authentication system of the present invention is applied in the using and authenticating the one-time electronic tickets. Accordingly, when the ticket data is authenticated, and the user is allowed to enter. The authentication reader 8 further issues a control instruction for commanding the authentication device 6 to delete the second ticket information D2 (step S28). As a result, the storage unit (such as the storage unit 63 shown in FIG. 5) of the authentication device 6 is cleared after the electronic ticket is used. Accordingly, the authentication device 6 is not required to install a storage unit 63 of high storage volume, and the manufacturing cost of the authentication device 6 is further reduced.

It should be noted that, the first ticket information D1 and the second ticket information D2 may further include other ticket information such as web pages, diagrams, advertisements, coupons etc. The user connects to the computer to enable the above information via a household authentication reader (not shown in the diagram) after the electronic ticket is used. Thus, the internal information is accessible to the user even the electronic ticket is a one-time ticket. Under the circumstance, the step S28 may be waived accordingly.

FIG. 5 is a block diagram of the authentication device of a preferred embodiment according to the present invention. As shown in the diagram, the authentication device 6 of the present invention includes a dual-interface transmission module 61, a micro processor 62 and a storage unit 63. The micro processor 62 is electrically coupled to the dual-interface transmission module 61 and the storage unit 63. In further details, a wired transmission interface 611 and a wireless transmission interface 612 are integrated into the dual-interface transmission module 61. The authentication device 6 is electrically coupled with the electronic device 4 via the wired transmission interface 611 for receiving the first ticket information D1 from the electronic device 4 and communicates with the authentication reader 8 via the wireless transmission interface 612 for wirelessly transferring the second ticket information D2 to the authentication reader 8 for performing authentication.

In the embodiment, the wired transmission interface 611 is a Serial Peripheral Interface (SPI), an Inter-Integrated Circuit (I2C) interface, a General Purpose I/O (GPIO) interface, and an Apple dock connector etc, but is not limited thereto. The wireless transmission interface 612 can be a Near Field Communication (NFC) interface or Radio Frequency (RF) interface etc. Also, the wireless transmission interface 612 can be a RF interface for Low Frequency (LF) frequency band and High Frequency (HF) frequency band, or a NFC interface for HF frequency band, but is not limited thereto.

The micro processor 62 is electrically coupled to the dual-interface transmission module 61 (i.e. simultaneously electrically coupled to the wired transmission interface 611 and the wireless transmission interface 612). The micro processor 62 is used for receiving the first ticket information D1 from the wired transmission interface 611 and saving the first ticket information D1 in the storage unit 63. Also, when the authentication reader 8 performs authentication, the micro processor 62 transforms the first ticket information D1 into the format to be transmitted by the wireless transmission interface 612 and encrypted the first ticket information D1 to generate the second ticket information D2. In further details, the micro processor 62 records the device identification code of the authentication device 6, and encrypts the first ticket information D1 on the device identification code.

The authentication device 6 further has a power unit 64 electrically coupled to the micro processor 62. The power unit 64 can be a power battery for providing power to the authentication device 6. In the embodiment, the wireless transmission interface 612 is a NFC interface or a RF interface, whereby the authentication device 6 externally provides power from the power unit 64 via the wireless transmission interface 612.

The authentication device 6 also has a display unit 65 electrically coupled to the micro processor 62. The display unit 65 is a Light Emitting Diode (LED) or Liquid Crystal Display Module (LCM). The authentication device 6 commands the display unit 65 to light or display corresponding information when communicating with the authentication reader 8, whereby the user is informed if the authentication is completed. It should be noted that the display unit 65 receives required power from the power unit 64 or from the authentication reader 8 via the wireless transmission interface 612, and is not limited thereto.

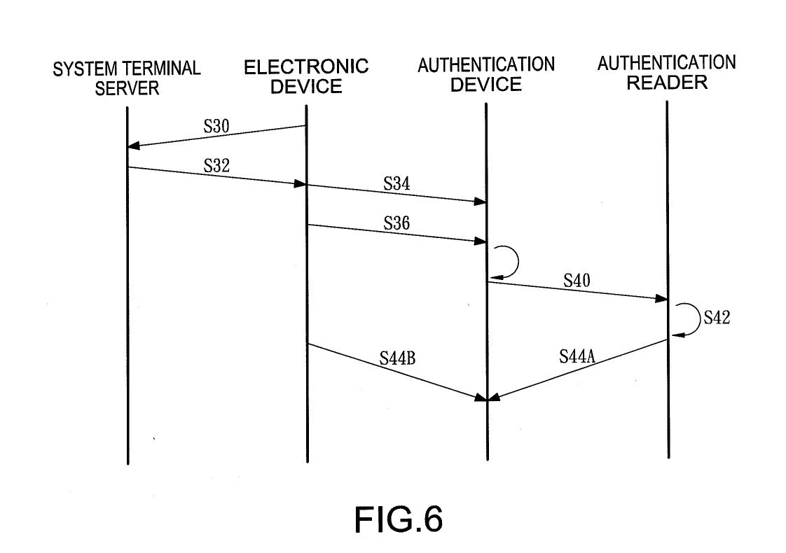

FIG. 6 is a flow chart of electronic ticket authentication of another preferred embodiment according to the present invention. When using the authentication system of the present invention, firstly, the user operates the electronic device 4 to connects to the system terminal server 7, and purchases electronic ticket from the system terminal server 7 (step S30). Next, upon the purchase and the payment procedures are completed, the system terminal server 7 transfers the first ticket information D1 of the electronic ticket purchased by the user to the electronic device 4 (step S32).

When the user desires to use the electronic ticket, the authentication device 6 connects to the electronic device 4 (step S34). Next, the application program 41 of the electronic device 4 is executed to load the first ticket information D1 into the authentication device 6 (step S36). Next, the authentication device 6 saves the first ticket information D1, transforms the first ticket information D1 into different format to be transmitted by the transmission interface and encrypts the first ticket information D1 to generate the second ticket information D2 (step S38). Lastly, the user uses the authentication device 6 for performing authentication on the electronic ticket.

When ticket agent checks the electronic ticket, the authentication reader 8 is used to wirelessly communicate with the authentication device 6. Also, the authentication reader 8 receives the second ticket information D2 from the authentication device 6 (step S40). Lastly, the authentication reader 8 decrypts the second ticket information D2, and generates the third ticket information D3 (step S42). Further, the decryption process determines if the second ticket information is correct or not, the content of the third ticket information D3 is used for determining if the electronic tickets is in line with the using requirement (such as determining if the date, time, play, place and seats are corrects). Also, when authentication is completed and determined correct, the user is allowed to enter.

Lastly, the authentication reader 8 issues a control instruction to the authentication device 6 for commanding the authentication device 6 to delete the second ticket information D2 (step S44A). Or, the authentication reader 8 may issue a control instruction to the electronic device 4 for commanding the authentication device 6 to delete the second ticket information D2 via the electronic device 4, (step S44B), but is not limited thereto.

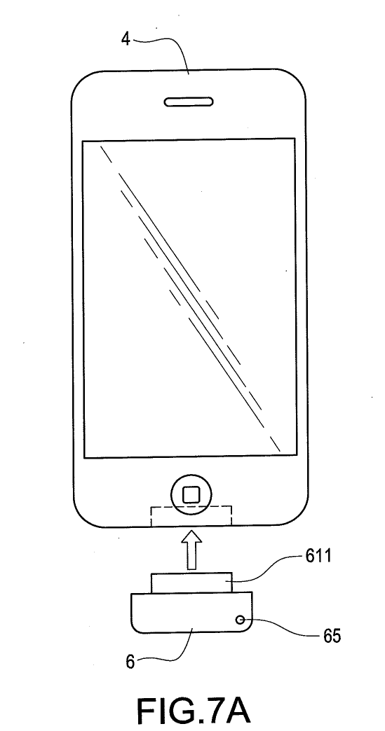

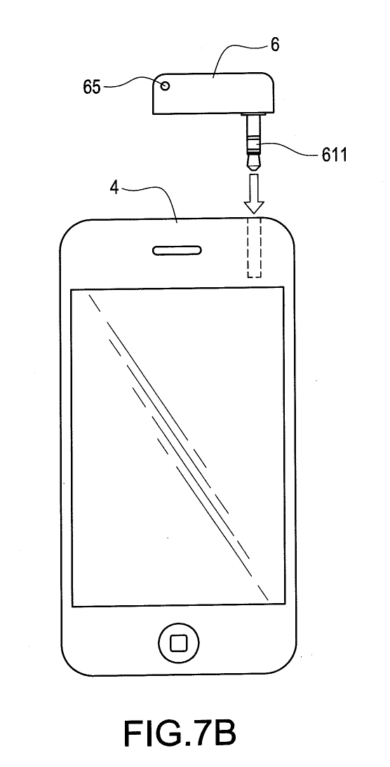

FIGS. 7A and 7B respectively are connection schematic diagrams of the authentication device of the first and the second preferred embodiments according to the present invention. As shown in FIG. 7, the authentication device 6 is electrically coupled to the electronic device 4 via a connecting port of a wired transmission interface 611 (as the example shown in FIG. 7A which is a 30 pins dock connector from Apple, but is not limited thereto). However, as shown in FIG. 7B, the wired transmission interface 611 of the authentication device 6 is an audio output/input interface, which is electrically coupled to the electronic device 4 via the earphone input port of the electronic device 4.

In the embodiment, the electronic device 4 transforms the first ticket information D1 from digital signals into analogue audio signals via the application program 41. The analogue audio signals can be set to be the frequency band which is not audible to human ears. Next, the electronic device 4 transmits the analogue audio signals to the authentication device 6 via the audio output/input interface, the authentication device 6 performs interpretation for recovering the analogue audio signals into the first ticket information D1 of digital format via the micro processor 62.

The objective of the embodiment is that different electronic devices 4 may have different transmission interfaces which are not compatible with each other. Nonetheless, the audio output/input interface of the different electronic devices 4 is the same because configuration of the earphone is standardized. Simulating the ticket data as the analogue audio signals and transmitted via the earphone input port is applicable to all kinds of electronic device regardless of the brand names and accordingly applicable to the authentication system of the present invention.

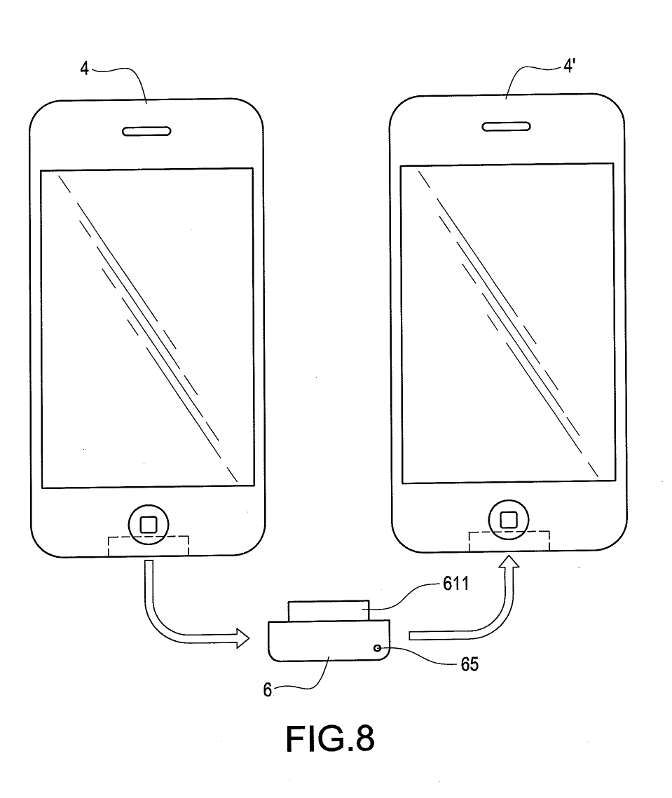

As mentioned in the background introduction above, a user has difficulty to resale the electronic ticket in the electronic device 4 when using the electronic device 4 for purchasing an electronic ticket which is bundled to the electronic device 4. FIG. 8 is a connection schematic diagram of the authentication device of the third preferred embodiment according to the present invention. In the embodiment, the electronic device 4 purchases, downloads and saves the first ticket information D1 of an electronic ticket. Next, the first ticket information D1 is loaded to the authentication device 6 and is encrypted to generate the second ticket information D2. Lastly, the user gives the authentication device 6 to the other user to be electrically coupled to the other electronic device 4′. In the embodiment, the other user commands the authentication device 6 to decrypt the second ticket information D2 via the application program 41 in the electronic device 4′, and loads the first ticket information D1 back to the electronic device 4′ to save in the electronic device 4′.

Thus, the user (or the other user) may carry the electronic device 4′. When the user desires to use the electronic ticket, the first ticket information D1 is loaded from the electronic device 4′ to the authentication device 6 (or the other authentication device) such that the authentication reader 8 is allowed to access and perform authentication on the first ticket information D1. As mentioned above, user is allowed to load the ticket data into the authentication device 6 anytime, and transfer, resale or give away the electronic ticket via the authentication device 6 based on the authentication system of the present invention. After the user purchases the electronic ticket, the electronic ticket is not bundled to the electronic device used for purchasing the ticket, which makes the electronic ticket more convenient and flexible to use for users.

As the skilled person will appreciate, various changes and modifications can be made to the described embodiments. It is intended to include all such variations, modifications and equivalents which fall within the scope of the invention, as defined in the accompanying claims.

What is claimed is:

1. An authentication system of electronic tickets use for purchase and authentication of one-time electronic tickets, the authentication system of electronic tickets include:
a system terminal server for issuing and recording the ticket data of at least one electronic ticket;
an electronic device for connecting with the system terminal server via the network system, purchasing at least one of the electronic tickets from the system terminal server, downloading and saving the ticket data of the electronic ticket;
an authentication device electrically coupled with the electronic device via a wired transmission interface for accessing to the ticket data of the electronic ticket from the electronic device; and
an authentication reader for communicating with the authentication device via the wireless transmission interface and receiving the ticket data in the authentication device and performing authentication on the ticket data.

2. The authentication system of electronic tickets of claim 1, wherein the authentication device includes:
a wired transmission interface whereby the authentication device receives the ticket data via the wired transmission interface from the electronic device;
a wireless transmission interface whereby the authentication device transmits the ticket data to the authentication reader via the wireless transmission interface;
a micro processor electrically coupled to the wired transmission interface and the wireless transmission interface for transforming the ticket data according to the different transmission interfaces and perform encryption on the ticket data; and
a storage unit electrically coupled to the micro processor for saving the ticket data received from the electronic device.

3. The authentication system of electronic tickets of claim 2, wherein the wired transmission interface and the wireless transmission interface are implemented by a dual transmission interface module.

4. The authentication system of electronic tickets of claim 2, wherein the wired transmission interface is selected from the group composed of a Serial Peripheral Interface (SPI), an Inter-Integrated Circuit (I2C), a General Purpose I/O (GPIO), and a dock connector.

5. The authentication system of electronic tickets of claim 2, wherein the wireless transmission interface is a Near Field Communication (NFC) interface or a Radio Frequency (RF) interface.

6. The authentication system of electronic tickets of claim 5, wherein the authentication device further includes a power unit electrically coupled to the micro processor for providing the required power to the authentication device, and the authentication device externally provides power from the power unit via the wireless transmission interface.

7. The authentication system of electronic tickets of claim 2, wherein the wired transmission interface is an audio output/input interface, the electronic device transforms the ticket data into analogue audio signals to transmits to the authentication device via the audio output/input interface, the authentication device recovers the analogue audio signals of the ticket data to digital signals of the ticket data via the micro processor.

8. The authentication system of electronic tickets of claim 2, wherein the authentication device further includes a display unit electrically coupled to the micro processor and the display unit emits lights when the authentication device communicates with the authentication reader.

9. The authentication system of electronic tickets of claim 2, wherein the electronic device is installed with an application program provided by the issuing end of the electronic ticket, the electronic device connects with the system terminal server via the application program, purchases and downloads the ticket data of the electronic tickets, and loads the ticket data into the authentication device.

10. An authentication method of electronic tickets used in the authentication system of claim 1, authentication method of the electronic tickets including:
a) connecting to the system terminal server via network system for purchasing the electronic ticket at the electronic device;
b) downloading the ticket data of the electronic tickets from the system terminal server after the purchase is completed at the electronic device;
c) loading the ticket data in the authentication device via the wired transmission interface at the electronic device;
d) communicating with the authentication device via the wireless transmission interface for receiving the ticket data from the authentication device at the authentication reader;
e) performing authentication to determine if the ticket data is correct at the authentication reader; and
f) re-accessing the ticket data in the authentication device at the authentication reader if the ticket data is incorrect.

11. The authentication method of electronic tickets of claim 10, wherein the method further includes a step g) issuing a control instruction at the authentication reader for commanding the authentication device to delete the internal ticket data if the ticket data is correct.

12. The authentication method of electronic tickets of claim 10, wherein the method further includes a step e0 before step e: performing decryption on the ticket data at the authentication reader.

13. The authentication method of electronic tickets of claim 12, wherein the ticket data is encrypted by the passwords of the system terminal server for generating a first ticket information in the step b; the authentication device performs encryption on the first ticket information via the default device identification code for generating a second ticket information in the step c; the authentication reader simultaneously receives the device identification code of the authentication device in the step d; the authentication reader performs decryption on the second ticket information via the device identification code and the passwords of the system terminal server to generate a third ticket information in the step e0.
